(19) United States
(12) Patent Application Publication
(10) Pub. No.: US 2008/0246387 A1
(43) Pub. Date: Oct. 9, 2008

(54) Image display device and manufacturing method of the same

(75) Inventors: Toshiaki Kusunoki, Tokorozawa (JP); Mitsuharu Ikeda, Kokubunji (JP); Katsuhide Aoto, Chiba (JP); Tomoki Nakamura, Chiba (JP); Yoshiro Mikami, Hitachiota (JP); Etsuko Nishimura, Hitachiota (JP); Takahiro Ueno, Miyazaki (JP); Mitsuaki Shiba, Mobara (JP)

Correspondence Address: REED SMITH LLP, Suite 1400, 3110 Fairview Park Drive, Falls Church, VA, 22042, US

(73) Assignee: Hitachi, Ltd.

(21) Appl. No.: 12/078,775

(22) Filed: Apr. 4, 2008

(30) Foreign Application Priority Data
Apr. 9, 2007 (JP) 2007-101859

(51) Int. Cl. H01J 63/04

(52) U.S. Cl. 313/496

(57) ABSTRACT

The present invention aims to form an electron emission film containing an alkali metal compound or the like without causing alkali attack on the metal wiring. An FED display device comprises: an electron source including an electron emission film 13 on the surface thereof; and metal wirings 17, 18 and the like for supplying a signal or the like to the electron source. After forming on the surface of the metal wiring 18 an corrosion resistant film 21 comprising a reactive film or adsorption film with phosphorus, an alkali metal or the like is coated onto or added into the electron emission film 13. The addition of phosphorus is made fewer than the chemical equivalent of the alkali metal salt. Such configuration can improve the electron emission efficiency of the electron source without the metal wiring being corroded by alkali metal or the like.

### CROSS-REFERENCE TO RELATED APPLICATION

The present invention is related to a U.S. patent application Ser. No. ______ being filed entitled “IMAGE DISPLAY DEVICE AND METHOD OF MANUFACTURING THE SAME” claiming the Convention Priority based on Japanese Patent Application No. 2007-101841 filed on Apr. 9, 2007.

### CLAIM OF PRIORITY

The present application claims priority from Japanese application JP2007-101859 filed on Apr. 9, 2007, the content of which is hereby incorporated by reference into this application.

### FIELD OF THE INVENTION

The present invention relates to image display devices, and is particularly suitable for an image display device, also called a self-luminous type flat panel display, using an electron source array and a phosphor screen.

### BACKGROUND OF THE INVENTION

An image display device (field emission display: FED) using a minute and integratable cold cathode type electron source has been developed. The electron sources of this type of image display device are classified into a field emission type electron source and a hot electron type electron source. The former includes a spindt type electron source, a surface conduction type electron source, and a carbon nano-tube type electron source, while the latter includes the thin film electron sources of an MIM (Metal-Insulator-Metal) type formed by laminating a metal layer, an insulator layer, and a metal layer, an MIS (Metal-Insulator-Semiconductor) type formed by laminating a metal layer, an insulator layer, and a semiconductor layer, an Metal-Insulator-Semiconductor-Metal type, and the like.

The MIM is reported, for example, in Patent Documents 1, 2, and as for the Metal-Insulator-Semiconductor type, an MOS type is reported in non-Patent Document 1, and as for the Metal-Insulator-Semiconductor-Metal type, a HEED type is reported in non-Patent Document 2, and the like, and an EL type is reported in non-Patent Document 3 and the like, and a porous silicon type is reported in non-Patent Document 4 and the like. An image display device may be configured by arranging such electron source described in these documents in a plurality of lines (e.g., in horizontal direction) and in a plurality of rows (e.g., in vertical direction) and thus forming a two-dimensional matrix and arranging a large number of phosphors corresponding to each thin film electron source within a vacuum.

(Patent Document 1) JP-A-7-65710

(Patent Document 2) JP-A-10-153979

(Non-Patent Document 1) J. Vac. Sci. Technol. B11 (2), pp. 429-432 (1993)

(Non-Patent Document 2) High-efficiency-electro-emission device, Jpn. J. Appl. Phys., Vol. 36, pp. 939-941 (1997)

(Non-Patent document 3) OYO BUTURI, Vol. 63, No. 6, pp. 592-595 (1994)

(Non-Patent document 4) OYO BUTURI, Vol. 66, No. 5, pp. 437-443 (1997)

### BRIEF SUMMARY OF THE INVENTION

In the case where an electron source array is applied to a display device, for either type of electron source, a field emission type or a hot electron type, an electron emission part having a lower work function can emit more electrons. Moreover, in the hot electron type electron source, the lower the band offset of the interface between an electron emission film and an electron acceleration layer, the more diode current can be obtained with a low drive voltage, and the emission current can be also increased. Furthermore, less gas adsorption to an electron emission surface can increase the emission current more.

For this reason, it is preferable that a compound of an alkali metal or an alkaline earth metal, an oxide thereof, or the like that is effective in reducing the work function of an electron emission film and also prevents gas adsorption due to the co-catalyst effect on the electron emission film is coated onto the electron emission film or added into the electron emission film. As a method for adding a compound of an alkali metal or an alkaline earth metal, an oxide thereof, or the like, onto an electron emission film or into the electron emission film, the present inventors have already disclosed that the amount of electron emission can be increased and the drive voltage can be lowered and the gas adsorption can be prevented by coating, drying, and calcining a solution of a salt or the like of an alkali metal or an alkaline earth metal and thereby adding the alkali metal or the alkaline earth metal or a compound thereof into the electron emission film.

However, many alkali metals, alkaline earth metals, and compounds thereof themselves often exhibit moisture absorption property or often exhibit alkalinity when used as a solution thereof during manufacturing process, so that these may corrode the metal wiring of a display device. In particular, hydroxides, carbonates, and the like have strong alkalinity and are likely to corrode the metal wiring of a display device. Moreover, even in the case where a salt solution having a low alkalinity or not exhibiting alkalinity is used, if a salt dissolves by a baking process and eventually changes into an alkali metal oxide or the like, then the alkali metal oxide or the like is likely to change, for example, by absorbing moisture, into a hydroxide of an alkali metal or an alkaline earth metal that exhibits a strong alkalinity, and the resultant hydroxide is likely to corrode the metal wiring of a display device. If a phosphate, hydrogen phosphate, or the like of an alkali metal or the like is used, a phosphate film on the surface of a metal wiring will exhibit the effect of preventing corrosion of the metal wiring depending on the material of the metal wiring, so that the metal wiring of a display device is unlikely to be corroded. However, since phosphorus is the material having a high electronegativity and having tendency to increase the work function, the phosphorus will offset the effect of reduction of the work function obtained by the addition of the alkali metal or the like and therefore the amount of emission current is difficult to be improved as compared with the case where a material other than phosphate is used.

On the other hand, in applying an electron source array to a display device, in particular in a large-sized image display device, such as a television application, the resistance of the metal wiring of a signal electrode or a scanning electrode needs to be reduced. For this reason, silver (Ag), copper (Cu), and aluminum (Al), an alloy mainly composed of these, and the like having low resistivity are often used as the wiring material. Among these, Al is a particularly preferable material since Al is an inexpensive material as compared with Ag and is a material having high oxidation resistance as compared with Cu, the material being capable of withstanding the high temperature glass sealing process of an image display device. However, Al is an amphoteric metal and thus has a drawback that particularly alkali corrosion is likely to occur.

It is an object of the present invention to provide an electron source array capable of obtaining a high emission current by making the metal wiring corrosion-resistant without causing a side effect such as an increase of the work function even if an alkali metal or an alkaline earth metal or a compound thereof is coated onto or added into an electron emission film, and to thereby achieve an image display device featuring high luminance, low power dissipation, low cost, and the like.

The above-described object can be achieved by an image display device comprising: an electron source array including an electron emission film which an alkali metal or an alkaline earth metal or a compound of an alkali metal or an alkaline earth metal is coated onto or added into; and a phosphor screen that is excited by bombardment of electrons emitted from the electron source array and thereby emits light, wherein at least a part of the surface of the metal wiring of the image display device and an electron emission film contain an alkali metal or an alkaline earth metal and phosphorus and at the same time contain such amount of phosphorus (P) that the composition ratio thereof is less than the chemical equivalent ratio of a salt of an alkali metal ion (+1 valence) or an alkaline earth metal ion (+2 valence) and an phosphoric acid (PO₄) ion (−3 valence).

The above-described object can be achieved by an image display device, wherein in particular, at least a part of the metal wiring of the image display device includes on the surface thereof a reactive film or adsorption film with phosphorus (P) or a phosphorus compound such as a phosphoric acid ion. The present invention exerts an effect particularly in image display devices using Al or Al-alloy wiring.

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory view of Example 1 of the present invention, showing a schematic plan view of an image display device using an MIM type thin film electron source as an example.

FIG. 2 is a view showing the operation principle of a thin film type electron source.

FIG. 3 is a view showing a method for manufacturing the thin film type electron source of the present invention.

FIG. 4 is a view following FIG. 3 showing the method for manufacturing the thin film type electron source of the present invention.

FIG. 5 is a view following FIG. 4 showing the method for manufacturing the thin film type electron source of the present invention.

FIG. 6 is a view following FIG. 5 showing the method for manufacturing the thin film type electron source of the present invention.

FIG. 7 is a view following FIG. 6 showing the method for manufacturing the thin film type electron source of the present invention.

FIG. 8 is a view following FIG. 7 showing the method for manufacturing the thin film type electron source of the present invention.

FIG. 9 is a view following FIG. 8 showing the method for manufacturing the thin film type electron source of the present invention.

FIG. 10 is a view following FIG. 9 showing the method for manufacturing the thin film type electron source of the present invention.

FIG. 11 is a view following FIG. 10 showing the method for manufacturing the thin film type electron source of the present invention.

FIG. 12 is a view following FIG. 11 showing the method for manufacturing the thin film type electron source of the present invention.

FIG. 13 is a view following FIG. 12 showing the method for manufacturing the thin film type electron source of the present invention.

FIG. 14 is a view following FIG. 13 showing the method for manufacturing the thin film type electron source of the present invention.

FIG. 15 shows the results of measurement using X-ray photoelectron spectroscopy on the surface of corrosion resistant Al wiring of the present invention.

FIG. 16 is a view following FIG. 14 showing the method for manufacturing the thin film type electron source of the present invention.

FIG. 17 is a view following FIG. 16 showing the method for manufacturing the thin film type electron source of the present invention.

FIG. 18 is a view following FIG. 17 showing the method for manufacturing the thin film type electron source of the present invention.

FIG. 19 shows the results of measurement of a depth direction element distribution of an electron emission film of the thin film type electron source of the present invention.

FIG. 20 shows the result of measurement of the variation in a power feed resistance of an electron emission electrode of the thin film type electron source of the present invention.

FIG. 21 is an explanatory view of Example 2 of the present invention, showing a schematic plan view of an image display device using a surface conduction type thin film electron source as an example.

FIG. 22 is an explanatory view of Example 3 of the present invention, showing a schematic plan view of an image display device using a spindt type thin film electron source as an example.

### DESCRIPTION OF REFERENCE NUMERALS

10 . . . cathode substrate, 11 . . . lower electrode, 12 . . . insulating layer (tunnel insulating layer), 13 . . . upper electrode, 14 . . . protective insulating layer, 15 . . . silicon nitride film, 16 . . . silicon film, 17 . . . upper bus electrode, 18 . . . contact electrode, 19 . . . undercut, 21 . . . corrosion resistant film, 22 . . . alkali (earth) metal salt, 24 . . . vacuum, 25 . . . resist film, 30 . . . spacer, 31 . . . signal electrode, 32 . . . scanning electrode, 33 . . . interlayer insulating film, 34 . . . contact electrode, 35 . . . electron emission film, 40 . . . frame glass, 41 . . . signal electrode, 42 . . . scanning electrode, 43 . . . interlayer insulating film, 44 . . . field emission chip, 50 . . . signal line driving circuit, 60 . . . scanning line driving circuit

### DETAILED DESCRIPTION OF THE INVENTION

Hereinafter, examples of the present invention will be described in detail with reference to the drawings of the examples. First, a first example of an image display device according to the present invention is described with an image display device using an MIM type electron source as an example.

### EXAMPLE 1

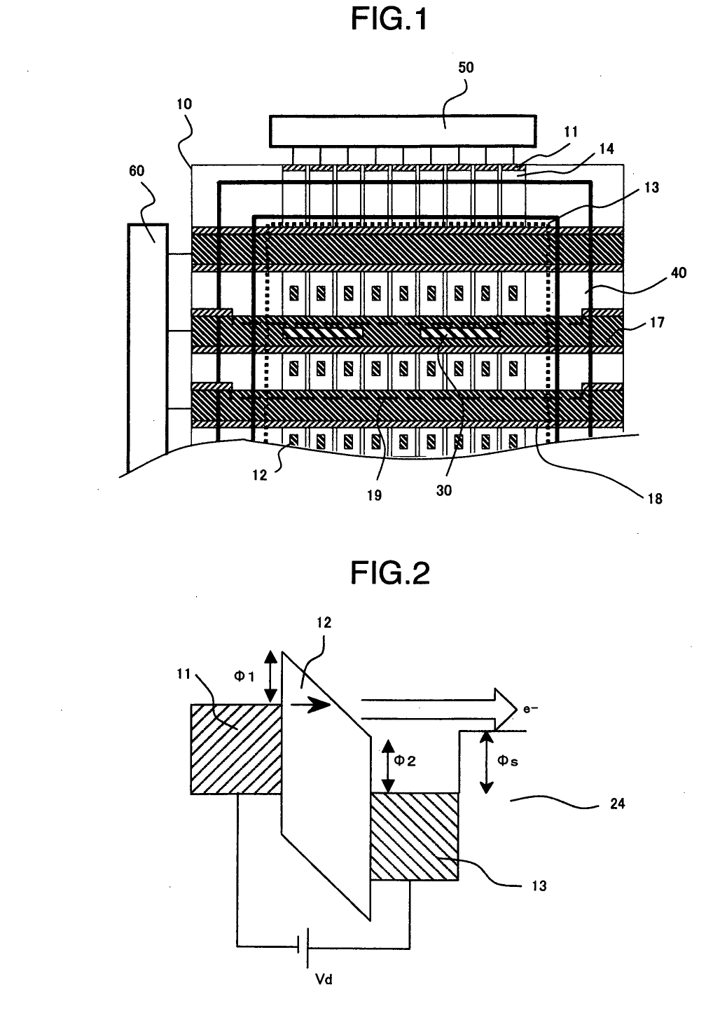

FIG. 1 is an explanatory view of Example 1 of the present invention, showing a schematic plan view of an image display device using an MIM type thin film electron source as an example. Note that FIG. 1 shows a frame glass 40 and the plane of a substrate (cathode substrate) 10 mainly comprising an electron source but omits other substrate (anode substrate) in which phosphor is formed.

In the cathode substrate 10, there are formed: a lower electrode 11 that constitutes a signal line (data line) coupled to a signal line driving circuit 50; an upper electrode 13 serving as an electron emission electrode; an upper bus electrode (power feed electrode to the upper electrode) 17 coupled to a scanning line driving circuit 60 and arranged perpendicular to the signal line; a contact electrode 18 for coupling the upper electrode, the contact electrode 18 overlapping with the upper bus electrode 17; a step structure (eave structure having such a shape that the scanning electrode may project from an end portion of the contact electrode) 19 for separating the upper electrode 13 for each scanning electrode; the later-described other functional films, and the like. Note that the electron source array (electron emission part) is arranged between the upper bus electrode 17 above the lower electrode 11 and is formed of the upper electrode 13 that is deposited above the lower electrode 11 via an insulating layer 12, wherein an electron is emitted from a portion of the insulating layer (tunnel insulating layer) 12 formed of a thin layer portion, the thin layer portion being surrounded by a thick protective insulating layer 14 that limits the electron emission part. In the cathode substrate of the present invention, the lower electrode, the upper bus electrode, and the contact electrode are formed of a reactive film containing Al and P (here, Al or an aluminum alloy whose surface is coated with aluminium phosphate (AlPO₄)), while an alkali metal or an alkaline earth metal, or a compound of an oxide or the like of an alkali metal or an alkaline earth metal is doped into the upper electrode.

FIG. 2 is the principle explanatory view of the MIM type electron source. In this electron source, if a drive voltage Vd is applied between the upper electrode 13 and the lower electrode 11 to set an electric field in the tunnel insulating layer 12 to around 1-10 MV/cm, then an electron in the vicinity of Fermi level inside the lower electrode 11 passes through a barrier by tunnel phenomenon, and is injected into the conduction band of the insulating layer 12, which is an electron acceleration layer and serves as a hot electron which then flows into the conduction band of the upper electrode 13. Among these hot electrons, those arriving to the surface of the upper electrode 13 with an energy of no less than a work function φₛ of the upper electrode 13 will be emitted into a vacuum 24. Accordingly, if an alkali metal or an alkaline earth metal or a compound of an alkali metal or an alkaline earth metal is doped into the upper electrode 13 to decrease the work function φₛ of the upper electrode 13, then more electrons are emitted into the vacuum 24, so that the electron emission efficiency will be improved.

Furthermore, the lower a band offset φ2 of the interface between the insulating layer 12 and the upper electrode 13 due to the doping of a compound of an alkali metal or an alkaline earth metal, the stronger the electric field applied to the insulating layer 12 with the same drive voltage Vd becomes, so that a low drive threshold voltage can be obtained.

Returning to FIG. 1, a spacer 30 is arranged above the scanning electrode 17 of the cathode substrate 10 so as to hide under a black matrix of a phosphor screen substrate (not shown). The lower electrode 11 serving as a signal electrode is coupled to the signal line driving circuit 50, and the scanning electrode 17 serving as the scanning electrode wiring is coupled to the scanning line driving circuit 60. The frame glass 40 is bonded to the cathode substrate 10 and phosphor screen substrate (not shown) with a frit glass, and the interior thereof is evacuated.

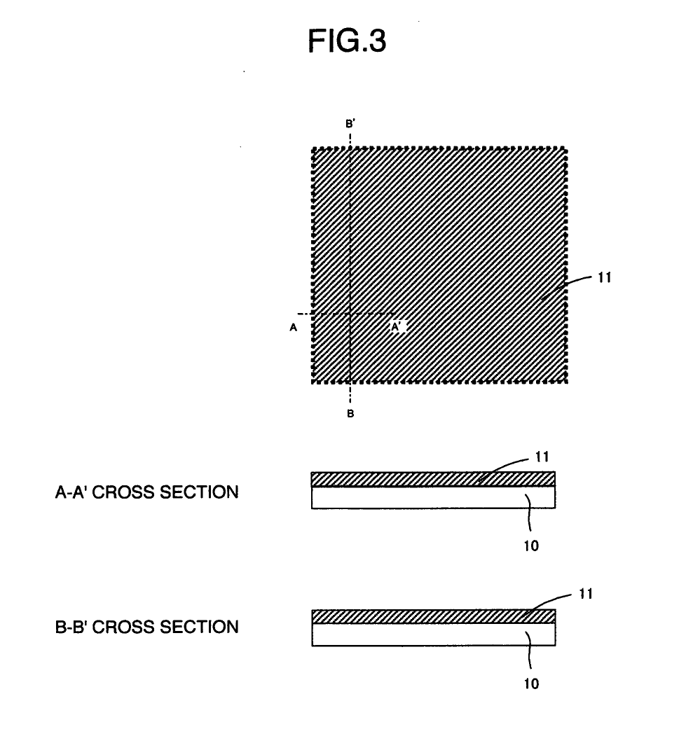

An example of a method for manufacturing the image display device of the present invention will be described with reference to FIG. 3 to FIG. 12. First, as shown in FIG. 3, a metal film used for the lower electrode 11 is deposited on the glass substrate 10. An Al-based material is used as the material of the lower electrode 11. The Al-based material is used because a quality insulating layer can be formed by anodic oxidation. Here, an Al—Nd alloy doped with 2% by atomic weight of Nd was used. In the deposition, sputtering is used, for example. The film thickness was set to 600 nm.

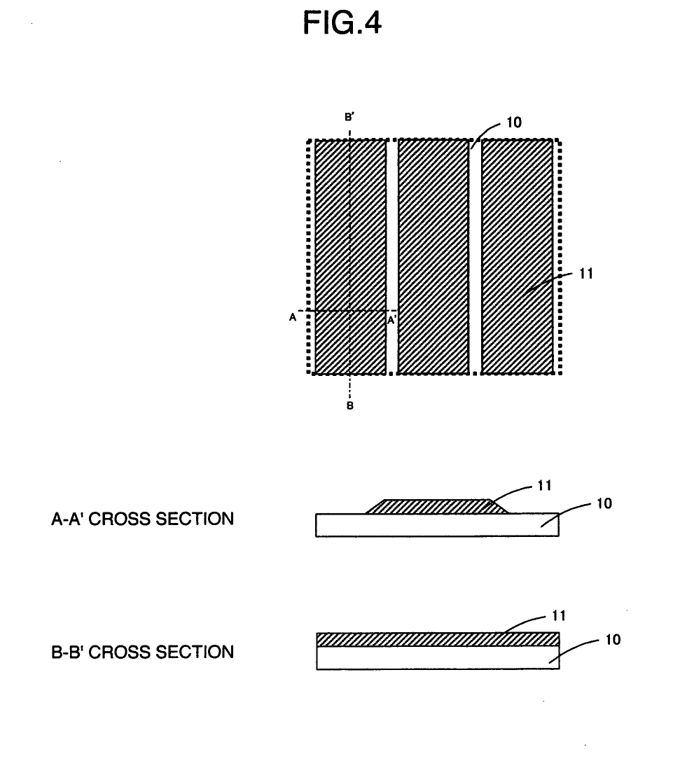

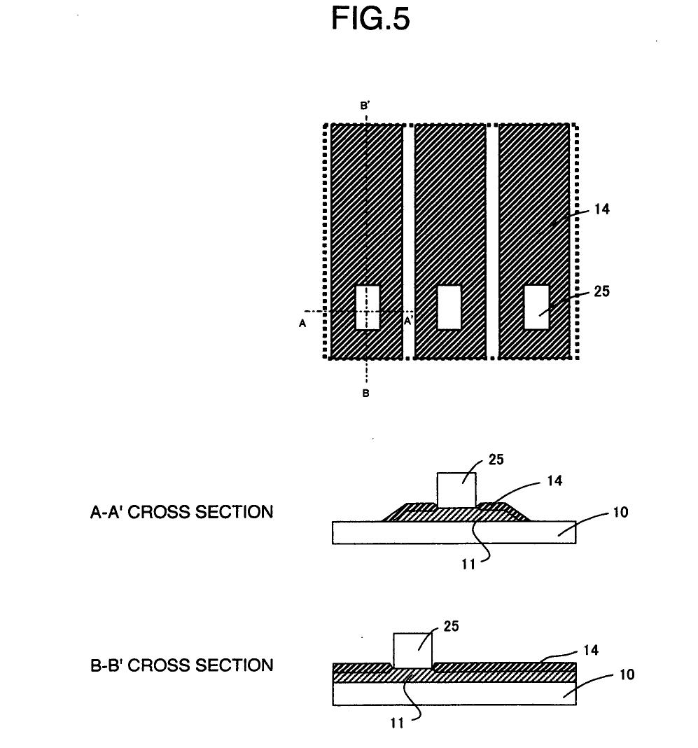

After the deposition, a stripe-shaped lower electrode 11 is formed by a patterning process and an etching process (FIG. 4). Although the electrode width of the lower electrode 11 varies depending on the size and resolution of the image display device, the electrode width is set on the order of the pitch of the subpixels thereof, i.e., on the order of approximately 100 to 200 μm. Since this electrode has a simple wide stripe geometry, the patterning of the resist can be carried out by an inexpensive proximity exposure method or a printing method or the like.

Moreover, since the lower electrode is the undermost layer film of the cathode substrate and various kinds of films are deposited thereabove, the end face thereof is preferably processed into a tapered shape. Then, wet etching in a mixed aqueous solution of phosphoric acid, acetic acid, or nitric acid as the etchant is used. An increase of the ratio of nitric acid can facilitate resist retraction during etching to finish the processed end face into a tapered shape.

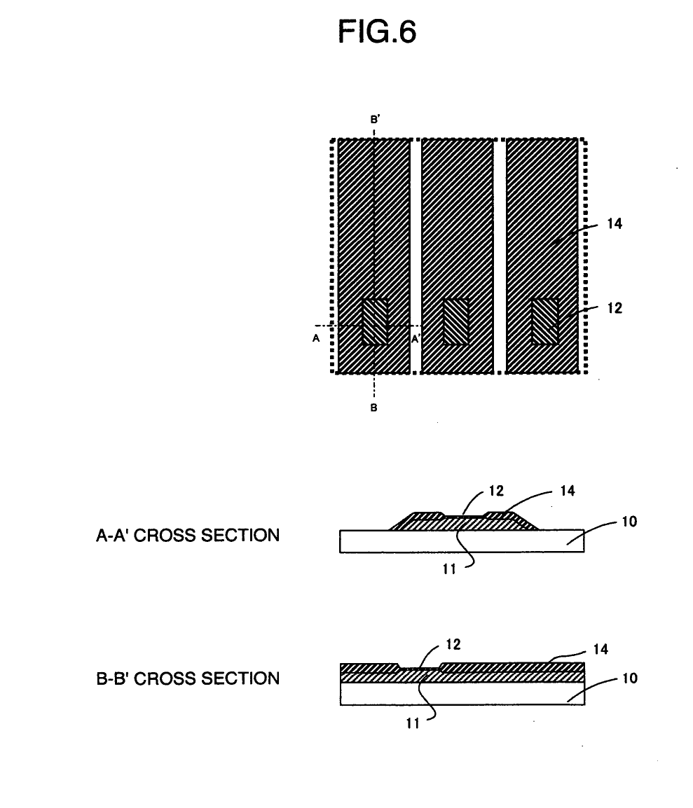

Next, the protective insulating layer 14 for limiting the electron emission part and preventing the electric field from concentrating on the edge of the lower electrode 11, and the insulating layer 12 are formed. First, a portion serving as the electron emission part above the lower electrode 11 shown in FIG. 5 is masked with a resist film 25, and other portion is selectively thickly anodized to serve as the protective insulating layer 14. With the formation voltage of 200 V, the protective insulating layer 14 with a thickness of approximately 280 nm is formed. Subsequently, the resist film 25 is removed to anodize the surface of the remaining lower electrodes 11. For example, with the formation voltage of 4 V, the insulating layer (tunnel insulating layer) 12 with a thickness of approximately 8 nm is formed on the lower electrode 11 (FIG. 6).

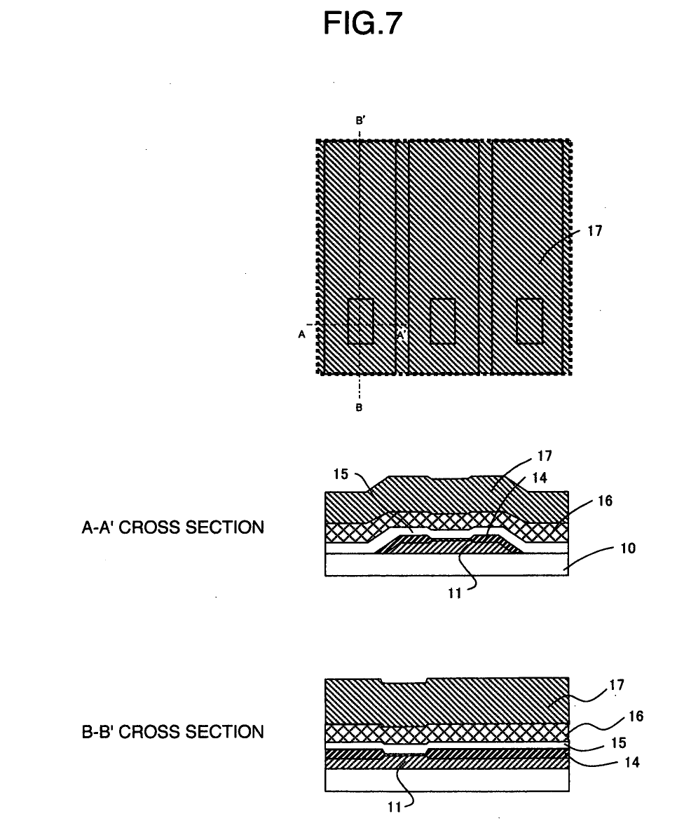

Next, an interlayer film (interlayer insulating film) 15 and a metal film serving as the upper bus electrode 17 serving as a power feeder to the upper electrode 13 are deposited, for example, by sputtering or the like (FIG. 7). As the interlayer film, for example, a silicon oxide, a silicon nitride film, or the like can be used. Here, a laminated film of a silicon nitride film 15 and a silicon film 16 is used and the film thicknesses thereof were set to 200 nm and 300 nm, respectively. If there is a pinhole in the protective insulating layer 14 formed by anodic oxidation, this silicon nitride film 15 serves to fill this defect and keep insulation between the lower electrode 11 and the upper bus electrode 17. Moreover, the silicon film 16 is used later for forming an undercut 19 on the side face of the upper bus electrode 17 and separating the upper electrode 13.

A metal film serving as the upper bus electrode 17 is deposited by sputtering or the like. Since the upper bus electrode 17 is used as the scanning electrode, the resistance thereof needs to be smaller than that of the lower electrode 13 serving as a data electrode, so that here Al having a low resistivity was used and the thickness thereof was set to 4.5 μm in order to reduce the wiring resistance.

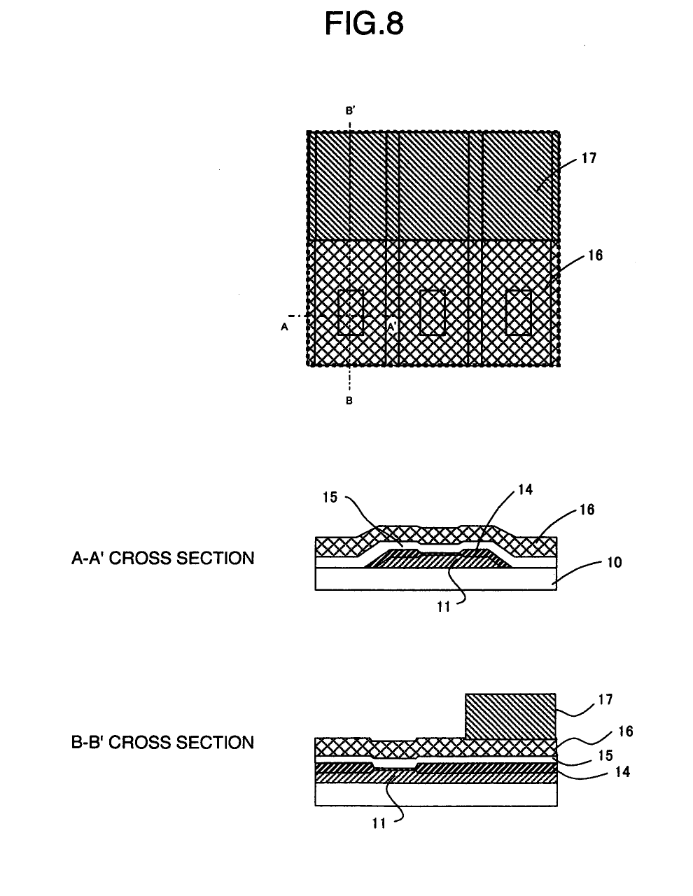

Next, the upper bus electrode 17 is processed. The upper bus electrode 17 is perpendicular to the lower electrode and is arranged beside the electron emission part. For the etching, wet etching in a mixed aqueous solution of phosphoric acid, acetic acid, or nitric acid is used, for example (FIG. 8).

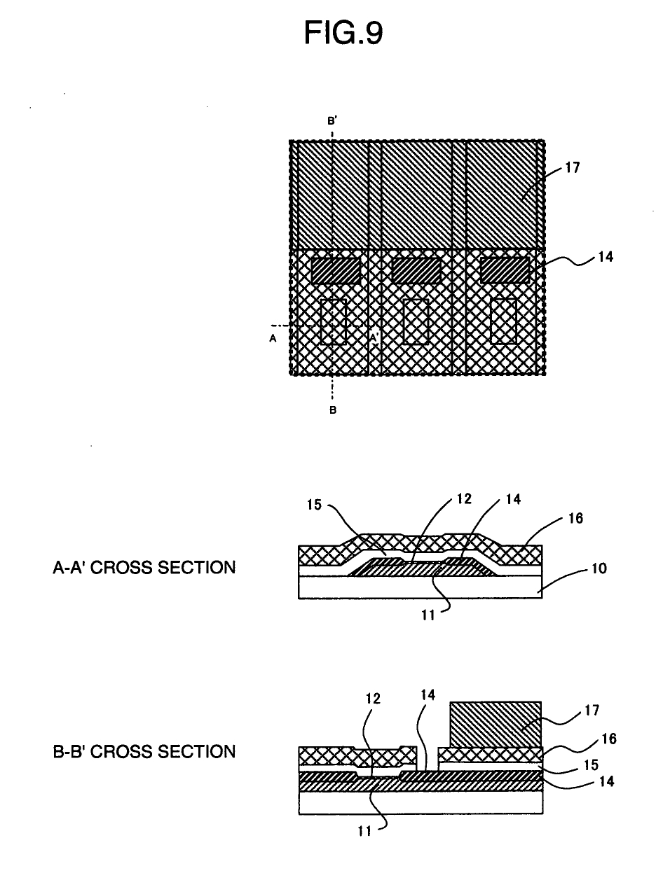

Subsequently, a through-hole is opened in the interlayer insulating film on the field insulating film 14 between the upper bus electrode 17 and the tunnel insulating layer 13. The etching can be performed by dry etching using an etching gas mainly composed of CF₄ or SF₆, for example, so as to etch the silicon nitride film 15 and silicon film 16 at the same time (FIG. 9).

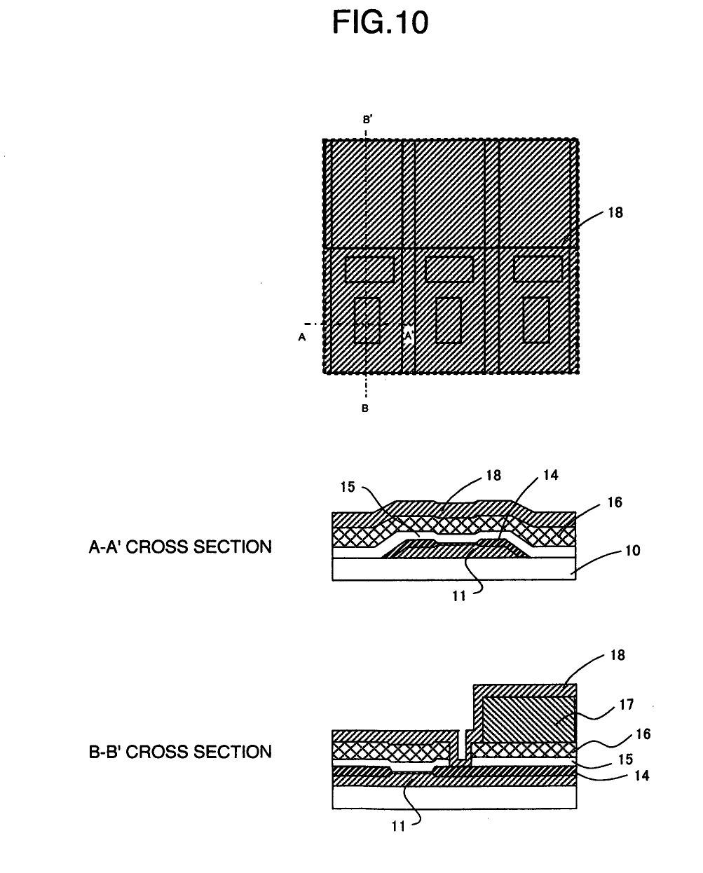

Subsequently, a metal film used for a contact electrode serving as a portion for electrically coupling the upper bus electrode to the upper electrode is formed by sputtering. For the metal film used for the contact electrode, as in the lower electrode, an Al—Nd alloy doped with 2% by atomic weight of Nd was used. For the deposition, sputtering is used, for example. The film thickness thereof was set to 300 nm (FIG. 10).

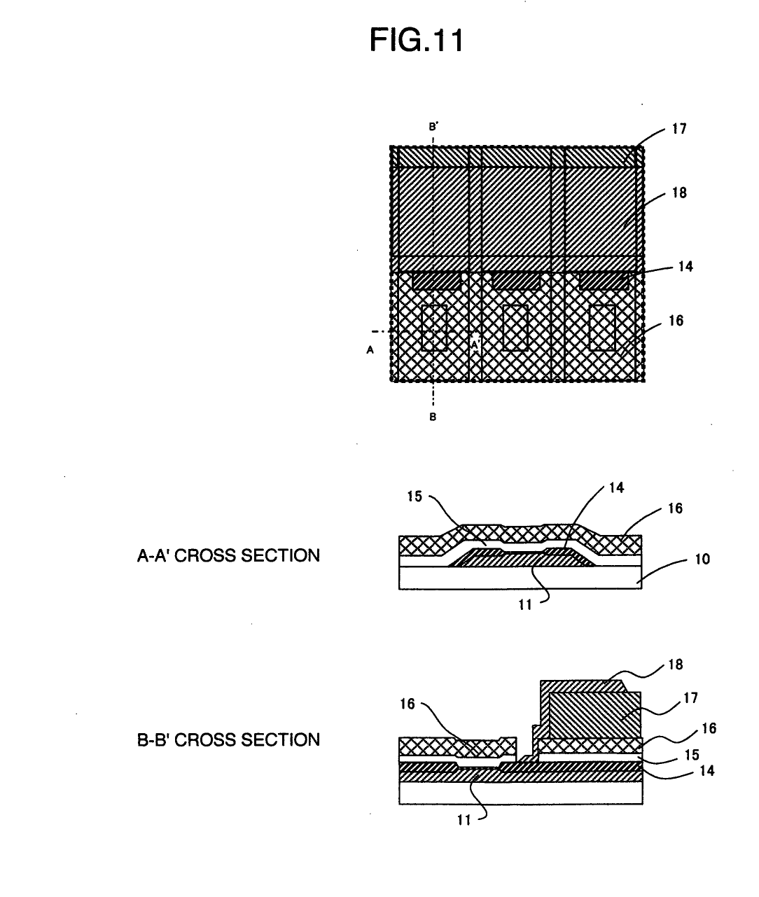

Subsequently, the contact electrode 18 is processed (FIG. 11). Since the contact electrode is processed into a tapered shape as in the lower electrode, wet etching in a mixed aqueous solution of phosphoric acid, acetic acid, or nitric acid, as the etchant, is used. An increase of the ratio of nitric acid can facilitate resist retraction during etching to finish the processed end face into a tapered shape.

The contact electrode 18 is, as shown in FIG. 11, processed into a shape in such a manner that the end face on the tunnel insulating layer 13 side crosses the interior of the through-hole and the end face on the opposite side of the tunnel insulating layer 13 lies above the upper bus electrode 17. By forming the end face of the contact electrode 18 inside the through-hole, it is possible to form the contact part above the field insulating film 14, so that the upper electrode 13 subsequently formed can be brought down from the upper bus electrode 16 to the field insulating layer 14 without via a step between the silicon nitride film 15 and the silicon film 16. This can prevent the upper electrode 13 from being cut off at the step.

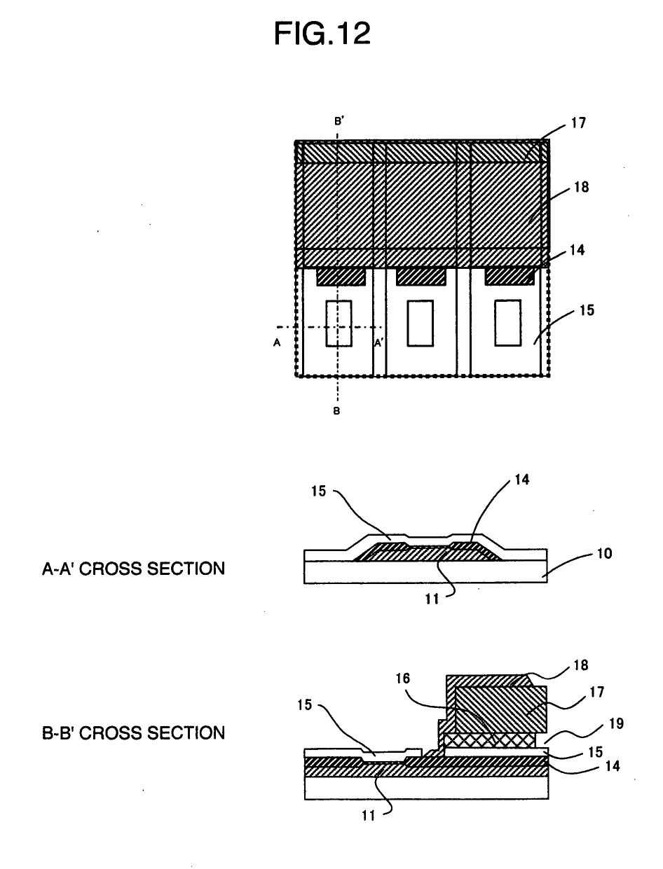

Subsequently, the silicon film 16 of the interlayer insulating film is dry-etched with high selectivity to the silicon nitride film 15 to form the undercut 19 beneath the side face on the opposite side of the upper bus electrode 17 (FIG. 12). The dry etching was carried out using a mixed gas of CF₄ and O₂ or a mixed gas of SF₆ and O₂. Although these gases etch both Si and SiN, the etching selectivity of Si can be increased by optimizing the ratio of O₂ (for example, CF₄:O₂=2:1). This undercut 19 serves to separate the upper electrode 13 for each upper bus electrode 17 (each scanning line) in forming the upper electrode 13 afterwards.

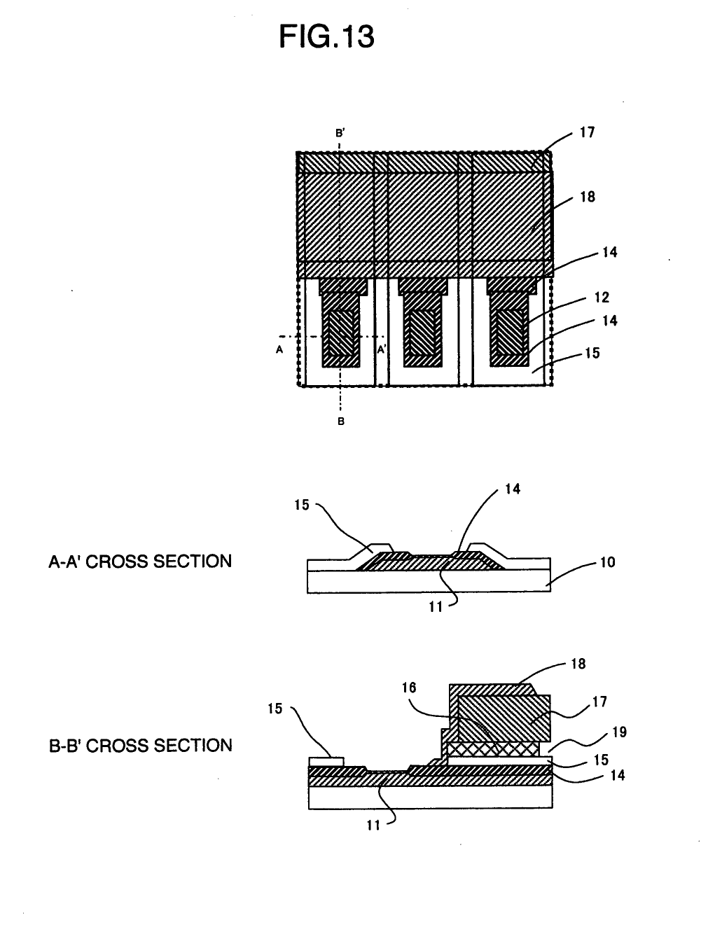

Subsequently, the silicon nitride film 15 on the electron emission part is processed to open the electron emission part. This etching can be carried out by dry etching using an etchant mainly composed of CF₄ or SF₆, for example (FIG. 13).

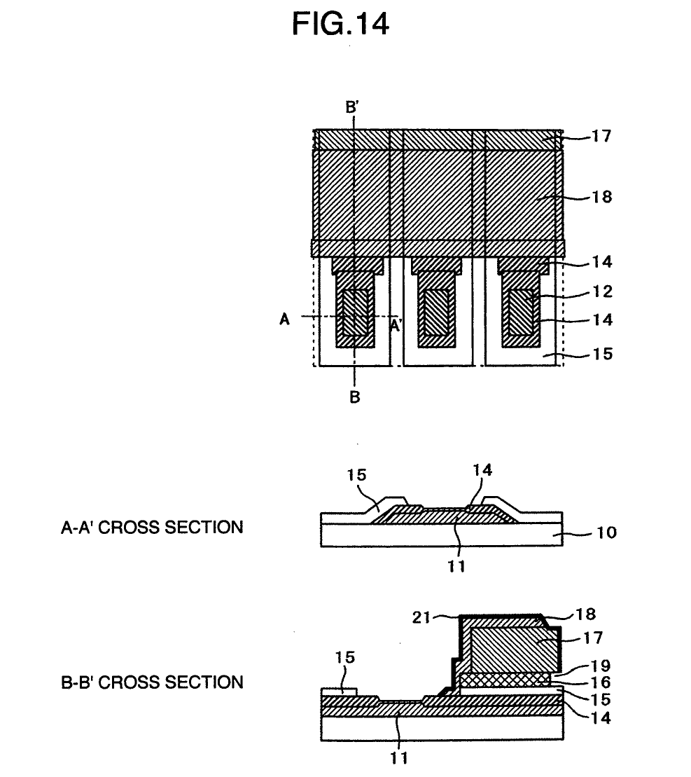

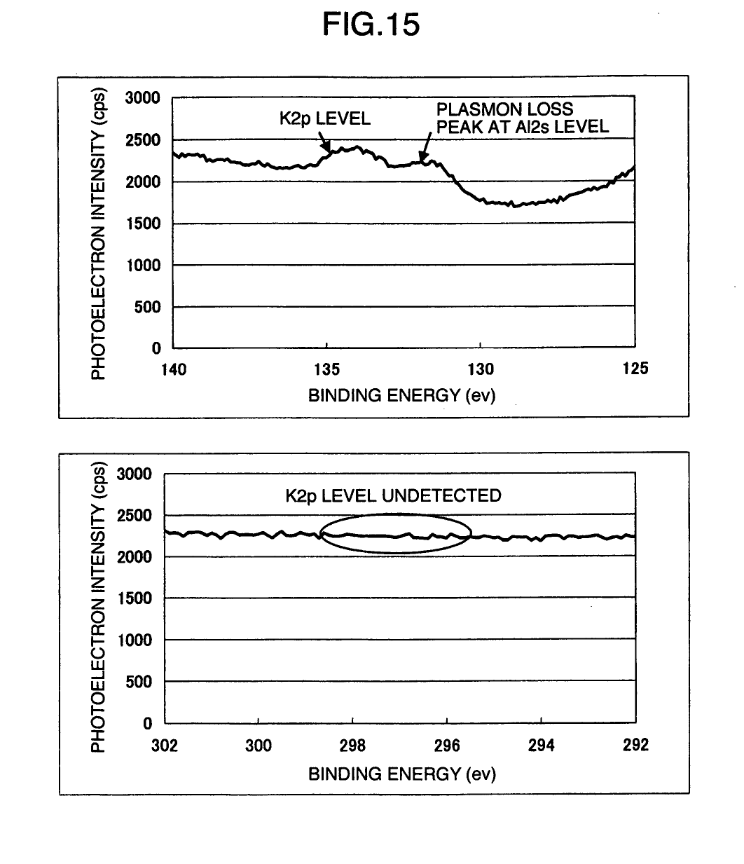

Next, an alkali corrosion resistant film 21 is formed on the surface of the lower electrode 11, upper bus electrode 17, and contact electrode 18 formed of an Al-based material (FIG. 14). The corrosion resistant film 21 is formed by dipping the entire cathode substrate 10 into an aqueous solution of phosphate or a hydrogen phosphate salt or by showering or spraying the same to the cathode substrate 10, thereby reacting Al and a phosphoric acid ion or adsorbing the phosphoric acid ion to the cathode substrate 10. Then, a counter ion of phosphate or hydrogen phosphate salt and an additional phosphoric acid ion are washed away by rinsing, and furthermore by hot-drying at no less than 100° C., it is possible to immobilize the reactive film or adsorption film with Al and P and leave this as the corrosion resistant film 21. FIG. 15 shows the results of analysis using X-ray photoelectron spectroscopy (XPS) on the surface of the Al film after forming the corrosion resistant film 21 using a aqueous solution of phosphorus hydrogen potassium. It is found that while phosphorus is detected on the Al surface, potassium which is the counter ion is not detected, and that the reactive film containing phosphorus (P) and the adsorption film containing P are formed on the Al surface.

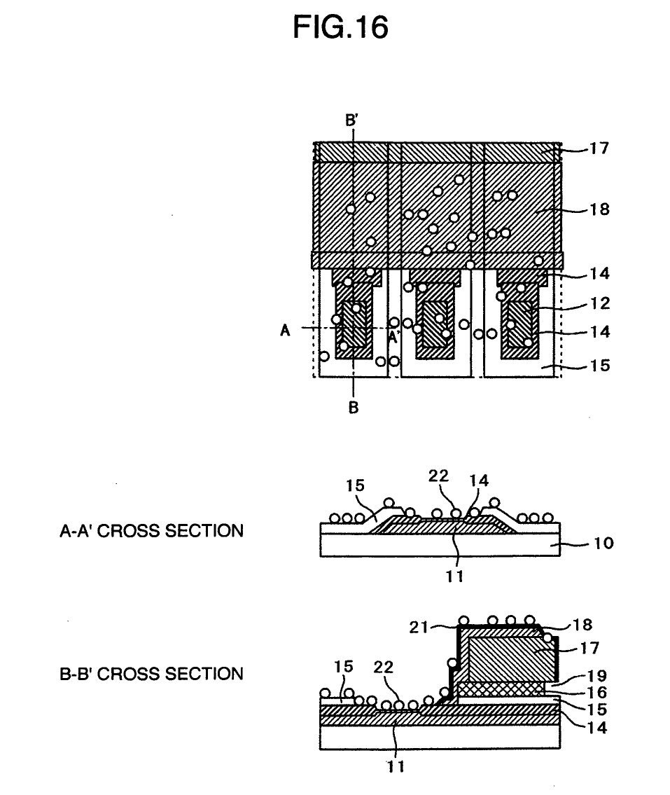

Next, an aqueous solution of a salt of an alkali metal or an alkaline earth metal is applied and dried (FIG. 16). Although the alkali (earth) metal salts are schematically dispersed and depicted in the view, these are actually applied uniformly at the atom level. Cs, Rb, K, Na, and Li are effective as the alkali metal, and Ba, Sr, Ca and Mg are effective as the alkaline earth metal. For the aqueous solution of an alkali metal salt, a salt neither containing phosphate nor a hydrogen phosphate salt, the salt being made of a material whose electronegativity is lower than that of phosphoric acid, for example, carbonate, hydrogen carbonate, acetate, borate, hydroxide, and the like can be applied. As the aqueous solution of an alkaline earth metal salt, hydroxide and the like can be applied. The amount to add may be suitably adjusted so that the work function becomes the lowest. In order to exhibit a work function reduction effect, an alkali metal or an alkaline earth metal containing lesser P than the amount of P in the reactive film containing phosphorus (P) or adsorption film containing P formed on the Al surface may be added. Specifically, an alkali metal or an alkaline earth metal containing lesser P than the amount of P corresponding to the chemical equivalent ratio of a salt of an alkali metal ion (+1 valence) or an alkaline earth metal ion (+2 valence) and an phosphoric acid (PO₄) ion (−3 valence) may be added. Namely, the amount of P contained in the reactive film or adsorption film may be less than the amount of P corresponding to the chemical equivalent ratio of a salt of an alkali metal ion (+1 valence) or an alkaline earth metal ion (+2 valence) and a phosphoric acid (PO₄) ion (−3 valence), and the difference should be as large as possible. Accordingly, thanks to the alkali metal or the alkaline earth metal or the like, the work function reduction effect is unlikely to be offset by P, and the amount of emission current can be increased and the gas adsorption preventive effect can be improved.

Here, a cesium carbonate aqueous solution was used. The cesium carbonate aqueous solution is an alkaline aqueous solution having pH of about 12 and usually etches Al, however, in this example since the corrosion resistant film 21 is formed on the Al surface in advance, Al is hardly etched even in the aqueous solution. Moreover, even if the cesium carbonate absorbs moisture during the processes after drying and eventually becomes a high alkaline state, the corrosion of Al wiring can be prevented.

Use of low-alkaline cesium hydrogen carbonate, cesium acetate, or the like is further effective. In this case, the corrosion resistant film 21 will exhibit an effect of preventing alkali attack when the cesium hydrogen carbonate or cesium acetate degrades into cesium oxide or into cesium hydroxide resulting from the cesium oxide absorbing moisture in the later-described sealing process, rather than at the time of coating with the aqueous solution.

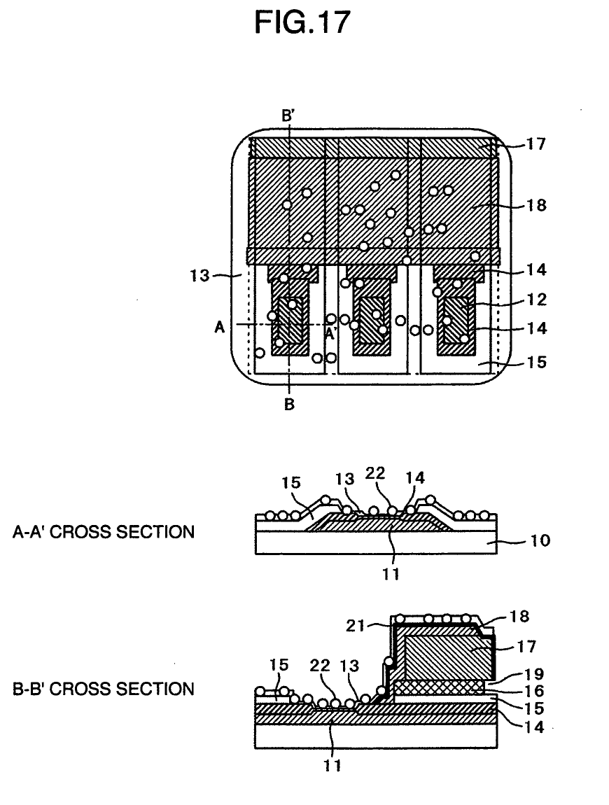

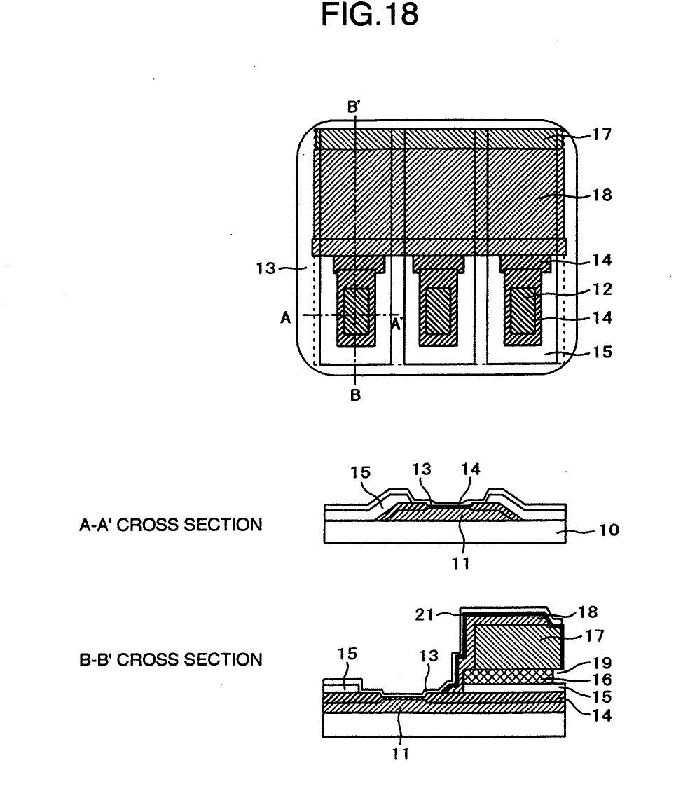

Then, the upper electrode 13 film is deposited by sputtering or the like. As the upper electrode 13, a platinum group of Group VIII or a noble metal of Group Ib having a high transmissivity of hot electrons is effective. In particular, Pd, Pt, Rh, Ir, Ru, Os, Au, Ag, a laminated film thereof, or the like is effective. Here, a laminated film of Ir, Pt, and Au was used and the film thickness ratio was set to 1:3:3 and the film thickness was set to 3 nm, for example, (FIG. 17).

Next, the cathode substrate and anode substrate constituting the image display device are calcined and sealed via the spacer and frame member using a glass frit by a high temperature process at 400° C. to 450° C. In this case, the compound of an alkali metal or an alkaline earth metal is thermally decomposed or oxidized and is mixed into the upper electrode, and a part having an alloy phase between the upper electrode material is alloyed to form an upper electrode doped with the alkali metal or alkaline earth metal. For example, when processed with carbonate Cs, the carbonate is thermally decomposed and oxidized into oxidized Cs or peroxide Cs, and a part thereof will react with Au to form an intermetallic compound, such as AuCs, Au₅Cs, or the like. In this case, Ir or Pt acts as a catalyst in the thermal decomposition of carbonate, helping facilitate the decomposition. Since this reduces the work function of the upper electrode 13, the electron emission efficiency is also improved.

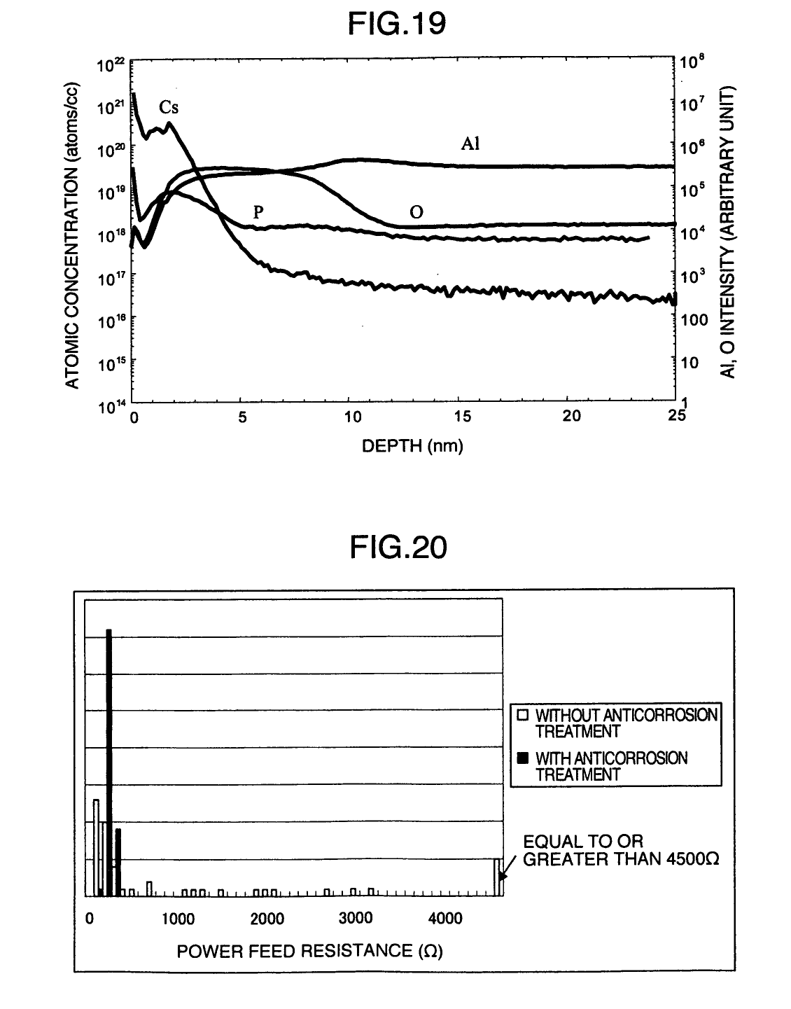

FIG. 19 shows a depth direction concentration distribution of Cs and P in the electron emission film measured by a secondary ion mass spectrometry. In the film surface, while the concentration of Cs is 10²⁰ to 10²¹ (atom/cc), P is 10¹⁸ to 10¹⁹ (atom/cc) and the content of P is about 1/100 of the content of Cs and thus the ratio of P is sufficiently low. Note that the concentration of Cs on the film surface is preferably no less than ten times as compared with the concentration of P. The concentration of Cs is higher than the concentration of P from the surface to 4 nm in depth. The concentration of Cs may be higher than the concentration of P from the film surface to 2 nm in depth.

Although FIG. 19 shows the results particularly in the case where Cs is added into the electron emission film, the same is true in the case of other alkali metal or other alkaline earth metal.

FIG. 20 shows the results of the measurement of the power feed resistance of the upper electrode 13 from the upper bus electrode 17 to the surface of the tunnel insulating layer 12 in the image display device. When the anticorrosion treatment of this example is not used, the power feed resistance varies up to several KΩ due to the corrosive oxidation of the surface of the contact electrode 18, increasing the power feed defects, while when the anticorrosion treatment of this example is used, the power feed resistance is an average of 200Ω and has few variations. Accordingly, a uniform image display can be achieved.

Moreover, also in portions other than the contact electrode for coupling the upper bus electrode 17 to the upper electrode 13, for example, in a terminal portion where the lower electrode 11 and the upper bus electrode 17 are coupled to the driving circuit, it is possible to similarly exhibit the anticorrosive effect and secure the connection reliability.

Note that, in this Example 1, although an image display device using an MIM type electron source 1 is taken as an example, the present invention is not limited to the MIM type electron source. Even in the hot electron type (electron source in which the electron acceleration layer is provided between the lower electrode and the upper electrode) described in the paragraph of the background art, the present invention is effective when an Al-based material is used as the wiring material and the one containing an alkali metal or an alkaline earth metal or a compound of an alkali metal or an alkaline earth metal is used as the upper electrode. As the electron acceleration layer in the case of other hot electron type, the one obtained by laminating semiconductor layers or by laminating a semiconductor layer and an insulation layer is used.

Hereinafter, for the examples of the present invention, the cases using a surface conduction type electron source array and a field emission type electron source array are described in Example 2 and Example 3. Since the basic principle of the present invention is the same, only the configuration and effect of Example 2 of an image display device are briefly described, here.

### EXAMPLE 2

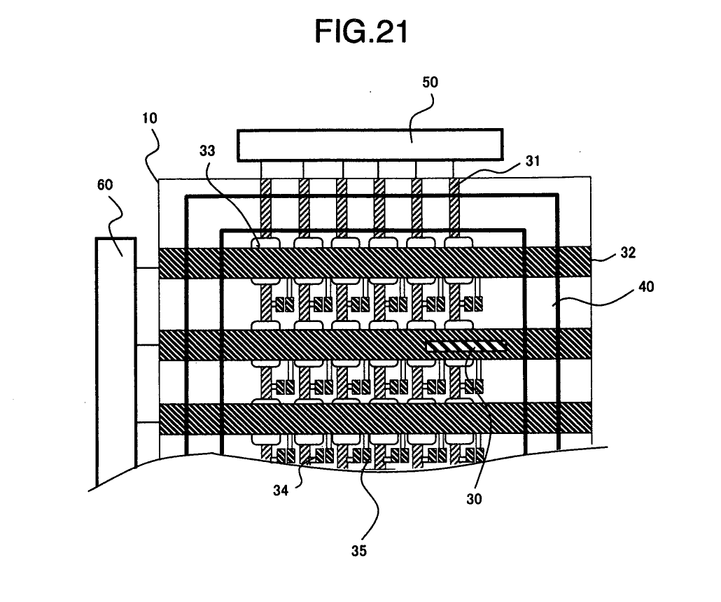

FIG. 21 is an explanatory view of Example 2 of the present invention, showing a schematic plan view of an image display device using a surface conduction type electron source as an example. Here, the frame glass 40 and the plane of the substrate (cathode substrate) 10 mainly comprising an electron source are illustrated, but other substrate (anode substrate) in which the phosphor screen substrate is formed is omitted.

In the cathode substrate 10, there are formed: a signal electrode 31 coupled to the signal line driving circuit 50; a scanning electrode 32 coupled to the scanning line driving circuit 60 and arranged perpendicular to the signal line; an interlayer insulating layer 33 for isolating the signal electrode 31 from the scanning electrode 32; a contact electrode 34 coupled to the signal electrode 31 and the scanning electrode 32, respectively; an electron emission film 35 coupled to the contact electrode 34 and having a crack, and the like. In the cathode substrate of the present invention, an Al-based material is used in either of the signal electrode 31, the scanning electrode 32, and the contact electrode 34, wherein the surface thereof is formed of a reactive film containing Al and P (here, Al or an aluminum alloy whose surface is coated with aluminium phosphate (AlPO₄)), and wherein an alkali metal or an alkaline earth metal or a compound of an alkali metal or an alkaline earth metal is doped into the electron emission film 35.

In the image display device using the surface conduction type electron source, a voltage is applied between the crack of the electron emission film 35, and some of electrons emitted from one of the electron emission films 35 are extracted by a high voltage of the phosphor screen, thereby causing a phosphor to emit light. Since the amount of electron emission can be increased by reducing the work function of the electron emission film, it is effective to reduce the work function by doping an alkali metal or an alkaline earth metal or a compound of an alkali metal or an alkaline earth metal into the electron emission film 35. In this case, the contact electrode 34 coupled to the electron emission film 35 needs to have the oxidation resistance for withstanding the sealing process and the alkali resistance required for doping an alkali metal or an alkaline earth metal or a compound of an alkali metal or an alkaline earth metal. For this reason, a noble metal or the like is often used, however, if the present invention is used, inexpensive Al can be used. Moreover, also for the signal electrode 31 and the scanning electrode 32, a low resistance and inexpensive material is preferable. There have been many examples using a printed wiring of Ag until now, however, if the present invention is used, the sputtered wiring of an inexpensive Al and the printed wiring of Al can be used.

### EXAMPLE 3

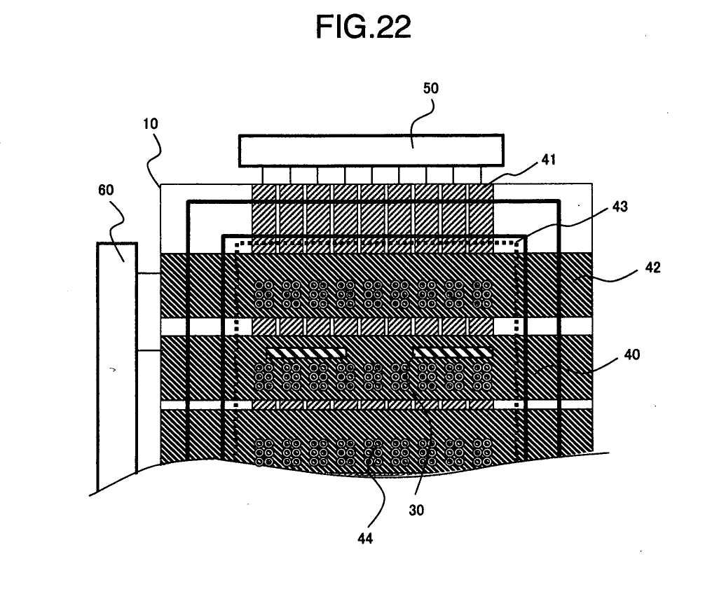

FIG. 22 is an explanatory view of Example 3 of the present invention, showing a schematic plan view of an image display device using a field emission type electron source as an example. Here, the frame glass 40 and the plane of the substrate (cathode substrate) 10 mainly comprising an electron source are illustrated, but other substrate (anode substrate) in which the phosphor screen substrate is formed is omitted.

In the cathode substrate 10, there are formed: a signal electrode 41 coupled to the signal line driving circuit 50, a scanning electrode 42 coupled to the scanning line driving circuit 60 and arranged perpendicular to the signal line 41; an interlayer insulating layer 43 for isolating the signal electrode 41 from the scanning electrode 42; and a field emission chip array 44 formed above the signal electrode 41 (or scanning electrode 42). In the cathode substrate of the present invention, an Al-based material is used in either of the signal electrode 41 and the scanning electrode 42, wherein the surface thereof is formed of a reactive film containing Al and P (here, Al or an aluminum alloy whose surface is coated with aluminium phosphate (AlPO₄)), and wherein an alkali metal or an alkaline earth metal or a compound of an alkali metal or an alkaline earth metal is coated onto or doped into the field emission chip 44.

In the image display device using the field emission type electron source, an electric field is focused on a tip of the field emission chip 44, and an electron emitted by field emission phenomenon is extracted to cause a phosphor to emit light. Since the amount of electron emission can be increased by reducing the work function of the electron emission chip 44, it is effective to reduce the work function by coating or doping an alkali metal or an alkaline earth metal or a compound of an alkali metal or an alkaline earth metal to the electron emission chip 44. In this case, the signal electrode 41 (or scanning electrode 42) coupled to the electron emission chip 44 needs to have the oxidation resistance for withstanding the sealing process and the alkali resistance required for doping an alkali metal or an alkaline earth metal or a compound of an alkali metal or an alkaline earth metal. If the present invention is used, an inexpensive Al-based material can be used in the signal electrode 41 or the scanning electrode 42.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGES OF THE INVENTION

If the above-described means for achieving the object is employed, then even in the case of an image display device using Al wiring or Al alloy wiring where alkali corrosion is likely to occur, a reactive film containing Al and P, for example, an adsorption film of aluminium phosphate (AlPO₄) or P (e.g., an adsorption film of phosphoric-acid-ion PO₄³⁻) passivates the Al surface and thus serves as an alkali corrosion-resistant film. For this reason, even if a material containing an alkali metal or an alkaline earth metal or a compound of an alkali metal or an alkaline earth metal is coated onto or added into an electron emission film, the Al wiring or Al alloy wiring will not be corroded by alkali, so that the reliability of the wiring and the contact performance between the electron emission film and the Al wiring can be secured.

1. A display device, comprising:
a cathode substrate in which an electron source emitting an electron is formed in the shape of an array and a wiring for supplying a current to the electron source is formed; and
a phosphor substrate, in which a phosphor, that is excited by an electron emitted from the electron source to emit light, is formed,
wherein the electron source or the wiring contains on a surface thereof an alkali metal or an alkaline earth metal and at the same time contains fewer amount of phosphorus than an amount of the alkali metal or alkaline earth metal.

2. The display device according to claim 1, wherein the alkali metal contains at least one of Cs, Rb, K, Na, and Li, and the alkaline earth metal contains at least one of Ba, Sr, Ca, and Mg.

3. The display device according to claim 1, wherein a concentration of the alkali metal or the alkaline earth metal is no less than 10²⁰ (atom/cc).

4. The display device according to claim 1, wherein on the surface of the electron source, an atomic concentration of an alkali metal or an alkaline earth metal is ten or more times of an atomic concentration of phosphorus.

5. The display device according to claim 1, wherein from the surface of the electron source to 2 nm in depth, an atomic concentration of an alkali metal or an alkaline earth metal is higher than an atomic concentration of phosphorus.

6. The display device according to claim 1, wherein from the surface of the electron source to 4 nm in depth, an atomic concentration of an alkali metal or an alkaline earth metal is higher than an atomic concentration of phosphorus.

7. The display device according to claim 1, wherein on the surface of the wiring, an atomic concentration of an alkali metal or an alkaline earth metal is ten or more times of an atomic concentration of phosphorus.

8. The display device according to claim 1, wherein the electron source comprises a lower electrode, an upper electrode, and insulator or semiconductor formed between the lower electrode and the upper electrode, wherein the wiring includes a power feed wiring to the lower electrode and a power feed wiring to the upper electrode, and wherein the power feed wiring to the lower electrode or the power feed wiring to the upper electrode is formed of Al or an Al alloy.

9. The display device according to claim 1, wherein the wiring includes a signal line and a scanning line, wherein the electron source is a surface conduction type electron source that emits an electron by applying a voltage between a crack of an electron emission film having the crack, the electron emission film being coupled to the signal line and the scanning line, wherein the signal line and the electron source are coupled to each other with a contact electrode, wherein the scanning line and the electron source are coupled to each other with a contact electrode, and
wherein the scanning line, the signal line, or the contact electrode is formed of Al or an Al alloy.

10. The display device according to claim 1, wherein the electron source is a field emission electron source comprising a signal electrode, a scanning electrode, and an interlayer insulating film provided between the signal electrode and the scanning electrode, wherein the field emission electron source emits an electron by applying an electric field to a field emission chip formed on an electrode arranged underneath either one of the signal electrode or the scanning electrode, from the other electrode, and wherein the signal electrode or the scanning electrode is formed of Al or an Al alloy.

11. A display device, comprising:
a cathode substrate in which an electron source emitting an electron is formed in the shape of an array and a wiring for supplying a current to the electron source is formed; and
a phosphor substrate, in which a phosphor, that is excited by an electron emitted from the electron source to emit light, is formed,
wherein the wiring contains phosphorus on a surface thereof.

12. The display device according to claim 11, wherein the wiring is formed of Al or an Al alloy.

13. The display device according to claim 12, wherein a compound of phosphorus and Al is formed on a surface of the Al or Al alloy.

14. The display device according to claim 13, wherein the compound is aluminum phosphate (AlPO₄).

15-16. (canceled)
